(19) United States
(12) Patent Application Publication
(10) Pub. No.: US 2019/0293315 A1
(43) Pub. Date: Sep. 26, 2019

(54) Increasing Battery Life of Wireless Sensor

(71) Applicant: Emerson Electric Co, St. Louis, MO (US)

(72) Inventor: Randy T. Ruiz, St. Peters, MO (US)

(21) Appl. No.: 16/155,803

(22) Filed: Oct. 9, 2018

Related U.S. Application Data
(60) Provisional application No. 62/645,470, filed on Mar. 20, 2018.

(51) Int. Cl. F24F 11/46; F24F 11/89; G05B 15/02

(52) U.S. Cl. CPC F24F 11/46; F24F 2120/10; G05B 15/02; F24F 11/89

(57) ABSTRACT

A method of operating a remote wireless sensor that is part of a control system for an HVAC system serving a space is disclosed. The remote wireless sensor is capable of operating in at least a first higher power mode and a second lower power mode. The method includes wirelessly transmitting a signal to the remote wireless sensor to cause the sensor to operate in the second lower power mode upon detecting the absence of an occupant in the space.

### CROSS-REFERENCE TO RELATED APPLICATION

The present application claims the benefit and priority of U.S. Provisional Application No. 62/645,470 filed Mar. 30, 2018. The entire disclosure of the above application is incorporated herein by reference.

### FIELD

The present disclosure relates to increasing battery life of a wireless sensor.

### BACKGROUND

This section provides background information related to the present disclosure which is not necessarily prior art.

This disclosure relates to climate control systems and in particular to remote wireless sensors used in the control of such systems.

Remote wireless sensors are in the control systems of climate control systems to obtain local information (such as temperature and/or humidity) within the space served by the climate control system, to improve the control and operation of the climate control system. These remote wireless sensors sense the local conditions, such as temperature and/or humidity, and periodically wirelessly communicate the information to the controller.

These remote wireless sensors are typically battery powered, and efforts have been made to reduce their power consumption to extend battery life and/or reduce the size of the battery required (and thus reduce the size of the device). Typically, these remote wireless sensors have two (or more) operating modes, which use power at different rates. The modes may differ in different power levels, different data rates, and/or frequency of transmission. While the higher power mode results in better communication of data and/or communication of more data, the lower power mode provides for longer battery.

Systems have been made to switch the sensors from a higher power mode to a lower power mode when it would not unduly interfere with the satisfactory operation of the control and/or the climate control system. Such a system is disclosed in U.S. Published Application US2017/0176035A1, where a controller such as a thermostat, executing a client control program, sends signals to remote wireless sensors that cause the remote wireless sensors in the system to switch to a lower power mode of operation. A problem with scheduled actions is that while there are many programmable thermostats, there are far fewer that are actually programmed, or at least actually programmed correctly. Also pre-established schedules do not always fit with actual usage.

### SUMMARY

This section provides a general summary of the disclosure, and is not a comprehensive disclosure of its full scope or all of its features.

The present disclosure provides a control system for a climate control system serving a space that includes remote wireless sensors, and a method of operating remote wireless sensors in such a control system. Generally, the control system for a climate control system according to the principles of this invention comprises a controller and at least one remote wireless sensor. The at least one remote wireless sensor wireles sly provides sensed data, such as temperature or humidity, to the controller. The at least one remote sensor has at least two modes of operation, each having different level of power consumption. In accordance with a preferred embodiment, the controller is configured to transmit a signal to the at least one remote wireless sensor upon determination that the space may be unoccupied. This signal causes the at least one remote wireless sensor to change to a mode of operation with a lower level of power consumption. Thus, in accordance with the principles of this invention, the remote wireless sensors are operated in lower power mode when the space is not occupied, and frequent updated information is less critical.

In some exemplary embodiments, the remote wireless sensors can include a motion sensor, and automatically change to a mode of operation with a higher level of power consumption upon the motion sensor sensing motion indicative of any occupant(s) in the space. In other exemplary embodiments, the controller is configured to transmit a signal to the remote wireless sensor upon determination that the space may be occupied, which causes the remote wireless sensors to change to a mode of operation with a higher level of power consumption. Alternatively, the system could include at least one motion sensor within the space, and the controller is configured to receive information from the at least one motion sensor and determine the occupancy of the space. In another alternative, the controller is configured to obtain information about devices connected to a router that is providing wireless communication within the space, and determine the occupancy of the space. In yet another alternative, the controller is configured to receive information about the presence or absence of particular devices within a geofence surrounding the space, and determine the occupancy of the space.

Another aspect of the disclosure provides a method of operating a remote wireless sensor that is part of a control system for an HVAC system serving a space. The remote wireless sensor is capable of operating in at least a first higher power mode and a second lower power mode. The method comprises wirelessly transmitting a signal to the remote wireless sensor to cause the sensor to operate in the second lower power mode, upon detecting the absence of an occupant in the space. Detecting the absence of an occupant in the space may comprise detecting the absence of occupants' cellular devices within the geofence. Detecting the absence of an occupant in the space may comprises polling a wireless network serving the space for connected devices, and detecting the presence or absence of occupants' cellular devices within the space. Detecting the absence of an occupant in the space may comprise receiving data from at least one motion sensor in the space.

The method can further comprise wirelessly transmitting a signal to the remote wireless sensor to cause the sensor to operate in the higher power mode, upon detecting the presence of an occupant in the space.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic diagram of a control system for a climate control according to a first exemplary embodiment;

FIG. 2 is a schematic diagram of a control system according to a second exemplary embodiment;

FIG. 3 is a schematic diagram of a control system according to a third exemplary embodiment;

FIG. 4 is a schematic diagram of a control system according to a fourth exemplary embodiment;

FIG. 5 is a schematic diagram of a control system according to a fifth exemplary embodiment;

FIG. 6 is a flowchart of a method for operating a remote wireless sensor in a control system for a climate control system according to an exemplary embodiment;

FIG. 7 is a flowchart of a method for operating a remote wireless sensor in a control system for a climate control system according to another exemplary embodiment; and

FIG. 8 is a flowchart of a method for operating a remote wireless sensor in a control system for a climate control system according to a further exemplary embodiment.

Corresponding reference numerals indicate corresponding (althouth not necessarily identical) parts throughout the several views of the drawings.

### DETAILED DESCRIPTION

Example embodiments will now be described more fully with reference to the accompanying drawings.

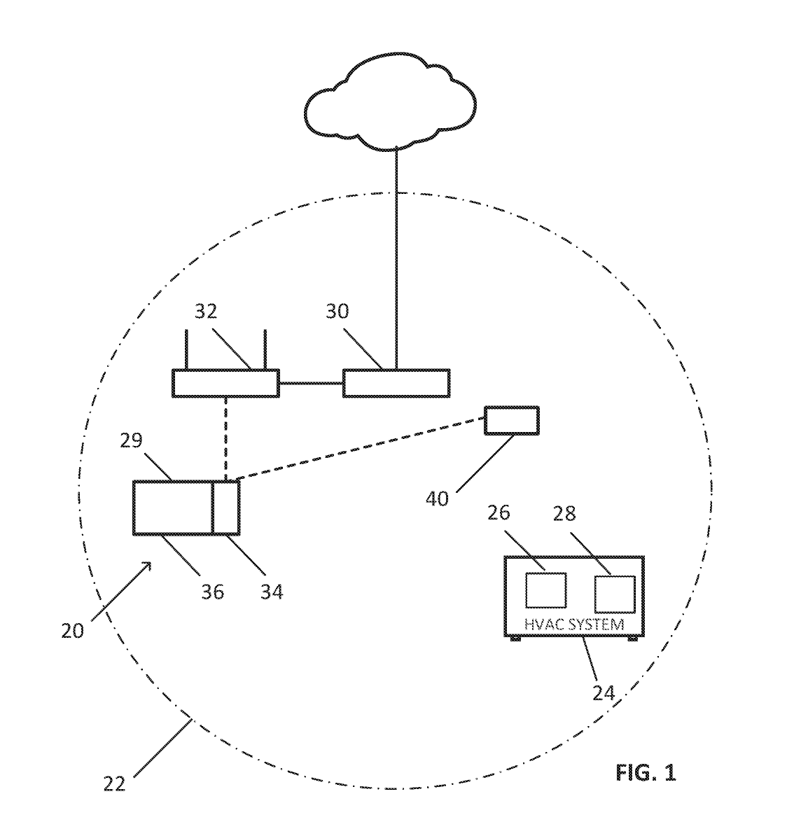

Embodiments of the present invention provide a control system for a climate control system serving a space that includes remote wireless sensors. A first preferred embodiment of a control system in accordance with the principles of this invention is indicated generally as 20 in FIG. 1. The control system 20 is adapted for operating a climate control system, such as HVAC system 24, serving a space 22. As shown in FIG. 1, HVAC system 24 may comprise a heater 26 and an air conditioner 28, but the climate control could comprise fewer, additional, or different components, depending upon the particular space 22 being controlled.

The control system 20 preferably comprises a control or controller 29, which is preferably a smart thermostat, such as the Sensi® smart thermostat available from Emerson Electric Co., St. Louis, Mo. The control 29 preferably includes a wireless communication system 34 and a processor 36. The wireless communication system 34 allows the control 29 to communicate with the Internet via a modem 30 and a router 32 serving the space 22.

The control system 20 also comprises at least one remote wireless sensor 40. The wireless remote sensor 40 provides sensed data, such as temperature or humidity within the space 22, to the control 29. The remote sensor 40 has at least two modes of operation, each having different level of power consumption, a lower power mode of operation and a higher power mode of operation. These modes may differ in different power levels, different data rates, and/or frequency of transmission. While the higher power mode results in better communication of data and/or communication of more data, the lower power mode provides for longer battery life.

In accordance with this first preferred embodiment, the control 29 is configured to determine when the space 22 (or at least a portion of the space served by sensor 40) may be unoccupied. The control 29 is further configured to transmit a signal to the at least one remote wireless sensor 40 upon determination that the space may be unoccupied. This signal causes the at least one remote wireless sensor 40 to change to a mode of operation with a lower level of power consumption. Thus, in accordance with the principles of this invention, the remote wireless sensor 40 is operated in lower power mode when the space 22 is determined to be occupied, and frequent updated information is less critical.

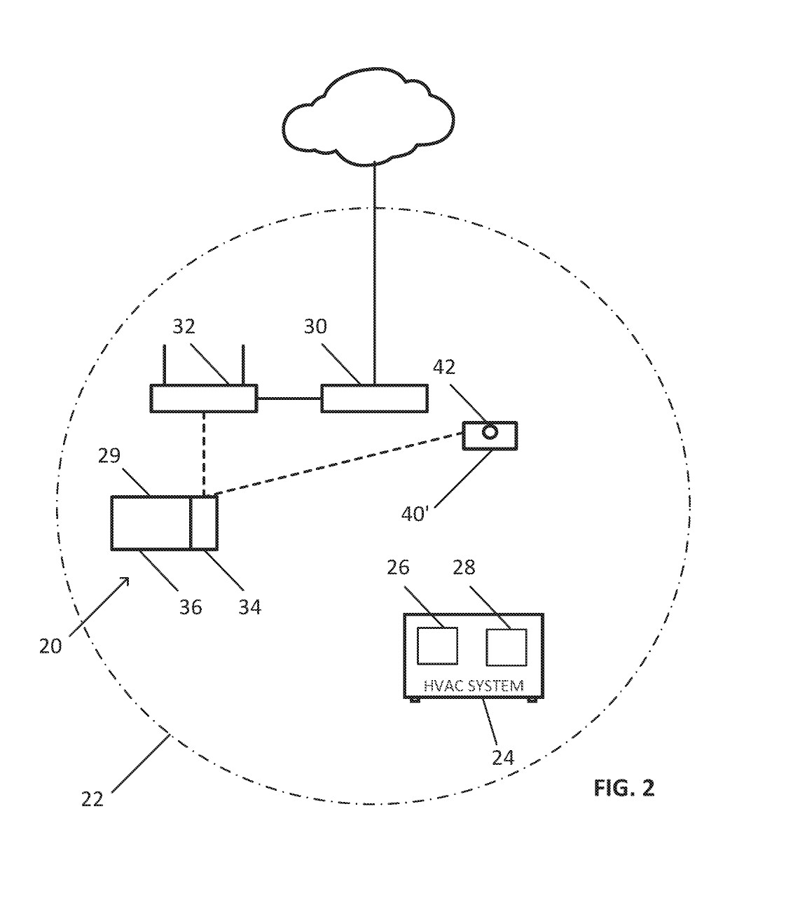

Preferably, once it is determined that the space 22 is again occupied, the remote wireless sensor 40 will change back to high power mode, to provide a higher level of data (e.g., more data, more frequent data, a higher power and more reliable data signal, etc.). In one alternate embodiment shown in FIG. 2, the remote wireless sensor 40′ includes a motion sensor 42. The remote wireless sensor 40′ automatically changes itself to a mode of operation with a higher level of power consumption upon the motion sensor 42 sensing motion indicative of an occupant(s) in the space 22.

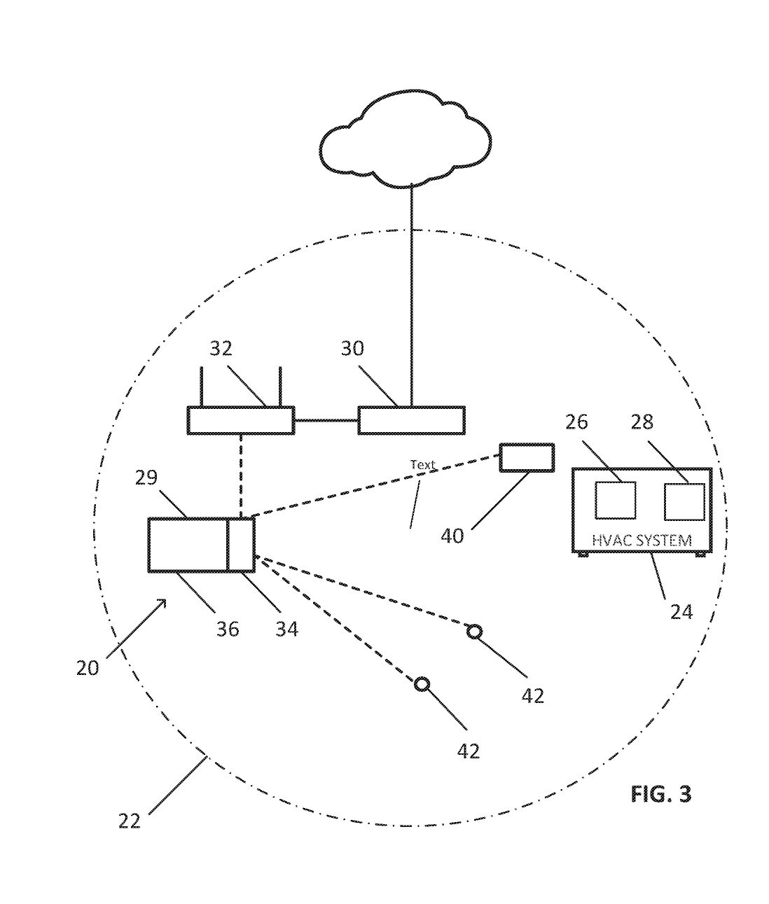

In other embodiments, the controller 29 is configured to transmit a signal to the remote wireless sensor 40 upon determination that the space 22 may be occupied, which causes the remote wireless sensor 40 to change to a mode of operation with a higher level of power consumption. For example, as shown in FIG. 3, the system 20 could include at least one motion sensor 42 within the space 22. The motion sensor 42 may communicate detected motion information from the space 22. The controller 29 is configured to receive information from the at least one motion sensor 42 and determine the occupancy of the space 22. If the controller 29 determines that the space 22 may be occupied, the controller 29 is configured to transmit a signal to the remote wireless sensor 40 upon determination that the space 22 may be occupied, which causes the remote wireless sensor 40 to change to a mode of operation with a higher level of power consumption.

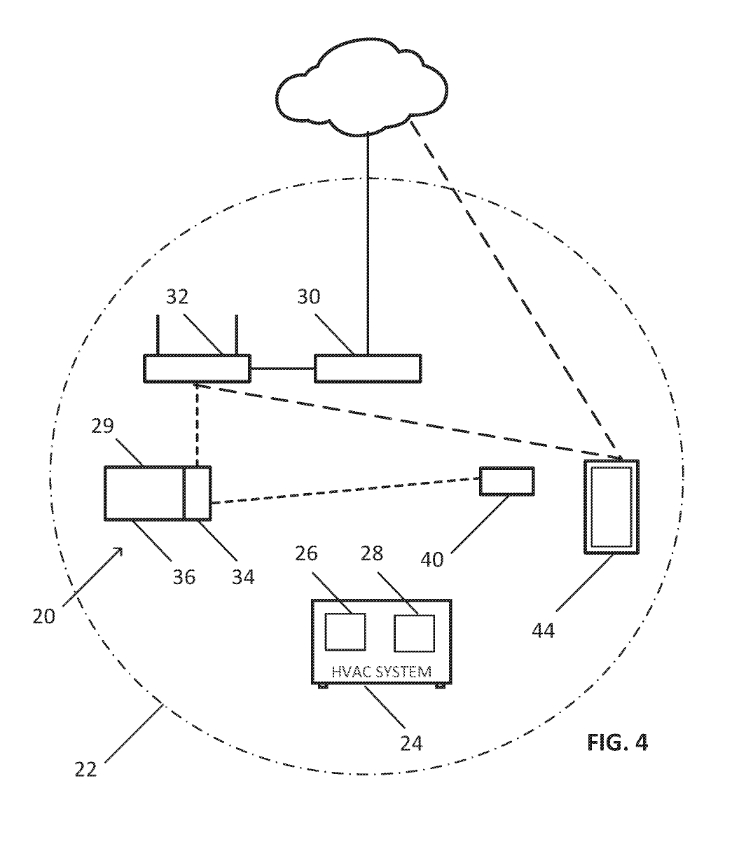

In another alternative shown in FIG. 4, the controller 29 is configured to obtain information about devices 44 connected to a router 32 that is providing wireless communication within the space 22, and determine the occupancy of the space 22. If the controller 29 determines that the space 22 may be occupied, the controller 29 is configured to transmit a signal to the remote wireless sensor 40 upon determination that the space 22 may be occupied, which causes the remote wireless sensor 40 to change to a mode of operation with a higher level of power consumption.

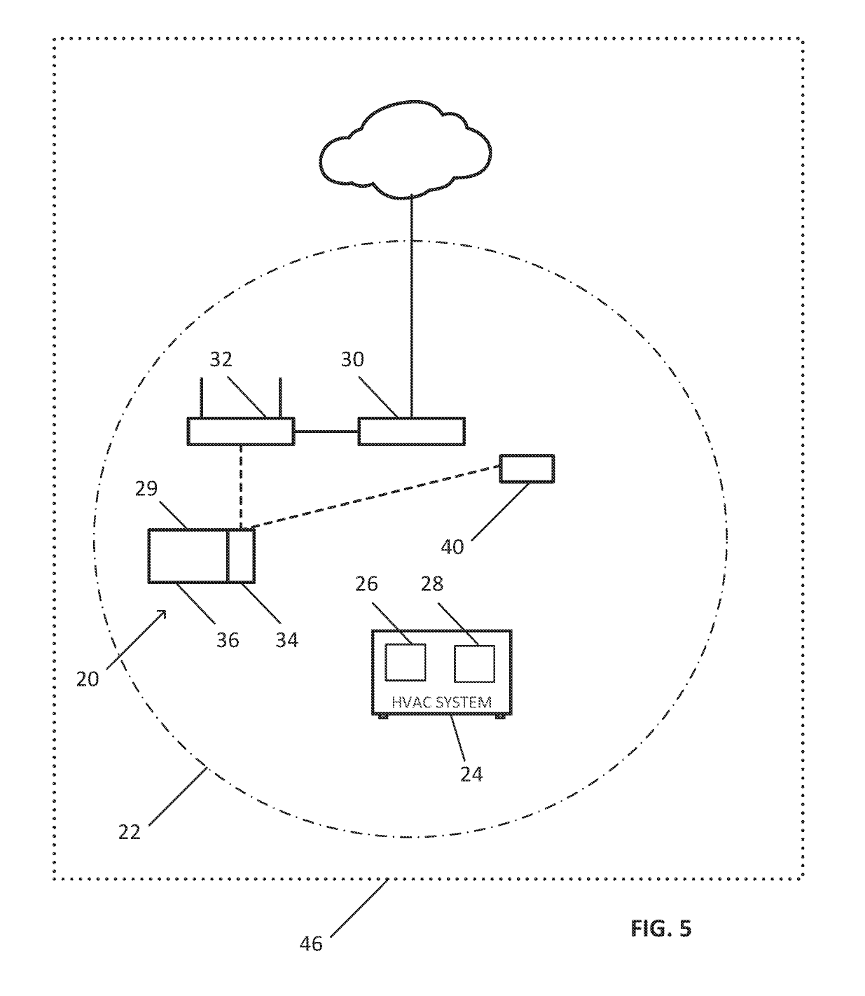

In yet another alternative shown in FIG. 5. the controller 29 is configured to receive information about the presence or absence of particular devices within a geofence 46 surrounding the space 22, and determine the occupancy of the space 22. If the controller 29 determines that the space 22 may be occupied, the controller 29 is configured to transmit a signal to the remote wireless sensor 40 upon determination that the space 22 may be occupied, which causes the remote wireless sensor 40 to change to a mode of operation with a higher level of power consumption.

Another aspect of the disclosure provides a method of operating a remote wireless sensor that is part of a control system for a climate control system serving a space. As described above, the remote wireless sensor 40 is capable of operating in at least a first higher power mode and a second lower power mode. The method comprises wirelessly transmitting a signal to the remote wireless sensor 40 to cause the remote wireless sensor 40 to operate in the lower power mode, upon detecting the absence of an occupant in the space 22. Detecting the absence of an occupant in the space 22 may comprise detecting the absence of occupants' cellular devices within the geofence 46. Detecting the absence of an occupant in the space 22 may comprises polling a wireless network router 32 serving the space for connected devices, and detecting the presence or absence of occupants' cellular devices 44 within the space 22. Detecting the absence of an occupant in the space 22 may comprise receiving data from at least one motion sensor 42 in the space 22. The method may further comprise wirelessly transmitting a signal to the remote wireless sensor 40 to cause the remote wireless sensor 40 to operate in the higher power mode, upon detecting the presence of an occupant in the space 22.

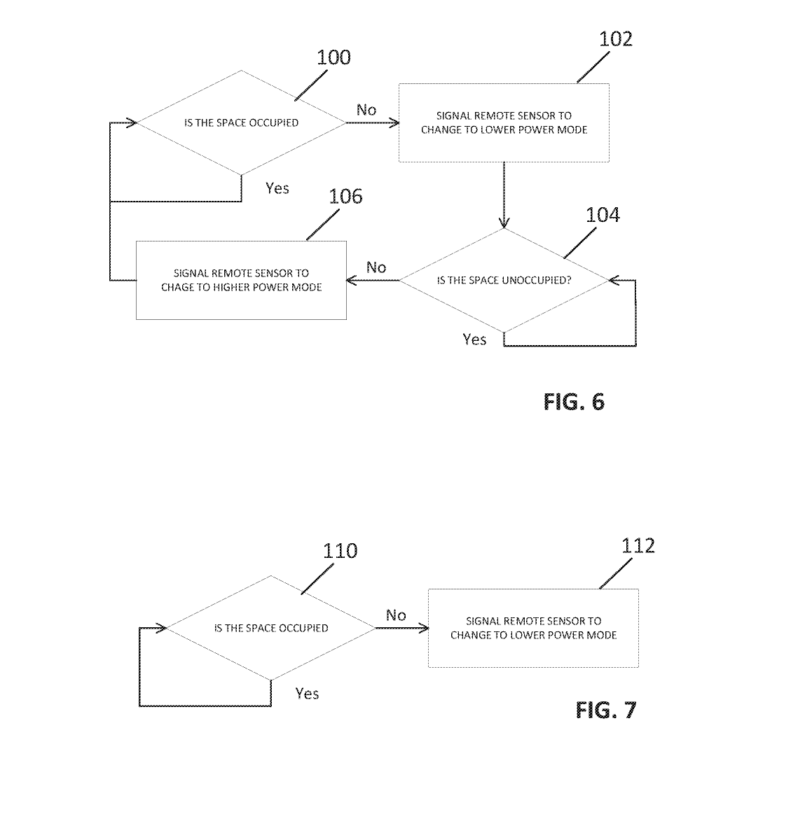

Logic that may be implemented by the control 29 is shown in FIG. 6. At 100, the control 29 determines whether the space 22 is occupied. If the space 22 is occupied, the control 29 enters a loop periodically checking whether the space 22 is still occupied. If the control 29 determines that the space 22 is not occupied, then at 102 the control 29 sends a signal to the remote sensor 40 to change to a lower power mode of operation. Then at 104, the control 29 determines whether the space 22 remains unoccupied. If so, the control 29 enters a loop periodically checking whether the space 22 is still unoccupied. If the space 22 is no longer unoccupied, then at 106 the control 29 sends a signal to the remote sensor 40 to change to a higher power mode of operation. The control 29 returns to 100 checking whether the space 22 is unoccupied.

In some embodiments, the remote wireless sensor 40 has its own motion sensor 42 (e.g., FIG. 2, etc.) and automatically changes to a higher power mode of operation when the sensor 42 detects motion in the space 22 indicating the presence of an occupant(s) in the space 22. In this case, the logic may be much simpler as shown in FIG. 7. At 110, the control 29 determines whether the space 22 is occupied. If the space 22 is occupied, the control 92 enters a loop periodically checking whether the space is still occupied. If the space 22 is not occupied, then at 112 the control 29 sends a signal to the remote sensor 40 to change to a lower power mode of operation.

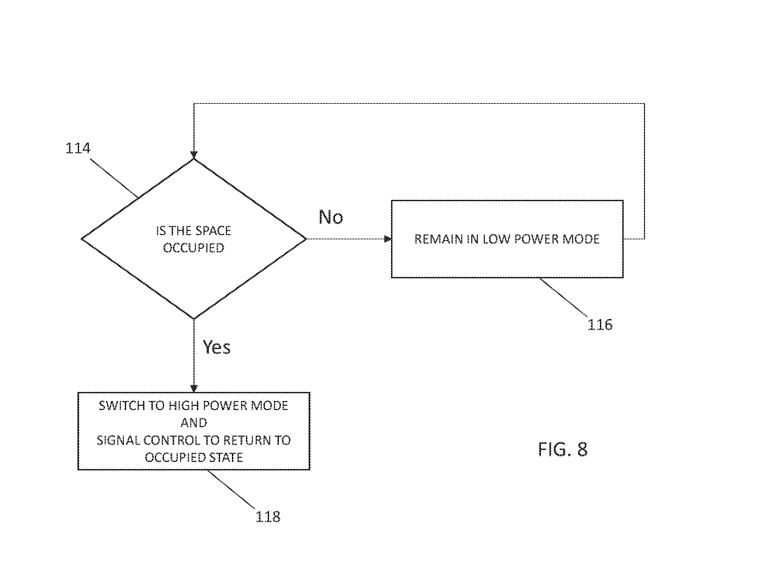

With reference to FIG. 8, some exemplary embodiments include the remote sensor 40 having the ability to detect occupancy. By of example, the remote sensor 40 may be in a low power consumption mode because of an instruction to do so from the controller 29. At 114, the remote sensor 40 determines whether the space 22 is occupied. If the space 22 is not occupied, then at 116 the remote sensor 40 remains in lower power mode and enters a loop periodically checking whether the space is still unoccupied. If the remote sensor 40 determines the space 22 is occupied at 114, then at 118 the remote sensor 40 switches from the lower power consumption mode to a higher power consumption mode. Also at 118, the remote sensor 40 sends a signal to the controller 29 indicating to the controller 29 that the remote sensor 40 has switched to the higher power consumption mode. Accordingly, the remote sensor 40 may thus override the lower power mode instruction from the controller 29 when the remote sensor 40 determines that the space 22 is occupied even though the controller 29 may have determined that the space 22 is unoccupied. The remote sensor's overriding of the lower power mode instruction from the controller 29 may also cause the controller 29 to return to an occupied state of operation, which may include the controller 29 adjusting the set point for operation of system 24 to an occupied value.

In contrast to scheduled power-downs that rely upon schedules being set and being followed, the ability to automatically change the operating mode of the remote wireless sensor 40 in the space 22 when the space 22 is unoccupied conserves battery power, and allows for sensor designs using smaller batteries.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method of operating a remote wireless sensor that is part of a control system for an HVAC system serving a space, the remote wireless sensor capable of operating in at least a first higher power mode and a second lower power mode, the method comprising wirelessly transmitting a signal to the remote wireless sensor to cause the sensor to operate in the second lower power mode upon detecting the absence of an occupant in the space.

2. The method according to claim 1, wherein the method includes wirelessly transmitting a signal to the remote wireless sensor to cause the sensor to operate in the first higher power mode upon detecting the presence of an occupant in the space.

3. The method according to claim 1, wherein detecting the absence of an occupant in the space comprises establishing a geofence around the space, and detecting the presence or absence of any occupants' cellular devices within the geofence.

4. The method according to claim 1, wherein detecting the absence of an occupant in the space comprises polling a wireless network service in the space for connected devices, and detecting the presence or absence of any occupants' cellular devices within the space.

5. The method according to claim 1, wherein detecting the absence of an occupant in the space comprises receiving data from at least one motion sensor in the space.

6. A control system for an HVAC system serving a space, the control system comprising:
a controller;
at least one remote wireless sensor for wirelessly providing sensed data to the controller, the at least one remote sensor having at least two modes of operation, each having different level of power consumption;
the controller configured to transmit a signal to the at least one remote wireless sensor upon determination that the space may be unoccupied, which signal causes the at least one remote wireless sensor to change to a mode of operation with a lower level of power consumption.

7. The control system according to claim 6, wherein the at least one remote wireless sensor includes a motion sensor, and wherein the at least one remote wireless sensor changes to a mode of operation with a higher level of power consumption upon the motion sensor sensing motion indicative of an occupant in the space.

8. The control system according to claim 6, wherein the controller is configured to transmit a signal to the at least one remote wireless sensor upon determination that the space may be occupied, which signal causes the at least one remote wireless sensor to change to a mode of operation with a higher level of power consumption.

9. The control system according to claim 6, further comprising at least one motion sensor within the space, and wherein the controller is configured to receive information from the at least one motion sensor and determine occupancy of the space.

10. The control system according to claim 6, wherein the controller is configured to obtain information about devices connected to a router providing wireless communication within the space, and determine occupancy of the space.

11. The control system according to claim 6, wherein the controller is configured to receive information about the presence or absence of particular devices within a geofence surrounding the space, and determine occupancy of the space.

12. The control system according to claim 6, wherein the controller receives information from the at least one remote wireless sensor indicating the space is occupied, and returns itself to an occupied state of operation.
